(19) United States
(12) Patent Application Publication
(10) Pub. No.: US 2024/0303580 A1
(43) Pub. Date: Sep. 12, 2024

(54) LOGISTICS PRE-ARRIVAL DECLARATION SYSTEM AND OPERATING METHOD THEREOF

(71) Applicants: Zhen-sheng Wang, SANTA FE SPRINGS, CA (US); Ze-Nong Wang, SANTA FE SPRINGS, CA (US); Ze-Feng Wang, SANTA FE SPRINGS, CA (US)

(72) Inventors: Zhen-sheng Wang, SANTA FE SPRINGS, CA (US); Ze-Nong Wang, SANTA FE SPRINGS, CA (US); Ze-Feng Wang, SANTA FE SPRINGS, CA (US)

(21) Appl. No.: 18/118,711

(22) Filed: Mar. 7, 2023

(51) Int. Cl. G06Q 10/0831; G06F 40/174

(52) U.S. Cl. CPC G06Q 10/0831; G06F 40/174

(57) ABSTRACT

The present disclosure provides a logistics pre-arrival declaration system and the operating method thereof. The declaration system connects the user device and the customs declaration system through the Internet. The declaration system includes a declaration form generating interface module, a form-checking and comparing unit and a database group. The database group includes a marine shipping database, a product database, an exporter database, an importer database, a marine shipping company database and a freight forwarding agency database. Users upload the marine shipment information to save in the database group of the system. When the user executes the declaration form generating interface module, the system fills the data of the database group into the generated form in the declaration form generating interface module. The users only require to confirm that the content of the generated form is correct, and the declaration form can be uploaded to the customs declaration system.

### BACKGROUND OF THE INVENTION

### 1. Field of the Invention

The present disclosure relates to a declaration system, and particularly to a logistics declaration system that reports to customs declaration system before arrival.

### 2. Descriptions of Related Art

International shipping requires extensive compliance with the regulations and requirements of various countries and regions. Countries establish regulations to control the goods from importing/exporting countries. Therefore, international goods that cross the borders would need to fulfill different rules and regulations in different countries. Each country has its own requirements and procedural restrictions for international transportation of product types, packaging, marks, addresses, shipping, buyer/seller information, etc. These requirements may or may not be the same across countries. Shipping companies and freight companies that violate transportation requirements may be subject to high fines, repatriation of goods, and suspension of the company's permission to enter and exit the country's ports.

It is quite difficult to comply with the regulations of the customs of various countries, and it is also complicated and difficult. In the past, all parties (shipping companies, transportation companies, importers, etc.) had to manually fill in the declaration documents before the cargo ship arrived at the port. Many forms in the declaration documents had to be compared one by one. Even if the electronic equipment is manually operated to input information (product, export/import party, destination, etc.), it is prone to human error and takes a long time to complete. It is challenging for the relevant operators of international cargo transportation to carry out international shipping. There is even a risk of being denied entry before the goods arrive. Therefore, it is necessary to have an appropriate electronic system to assist relevant operators in the customs declaration system of various countries.

### SUMMARY OF THE INVENTION

The present disclosure provides a logistics pre-arrival declaration system, connected with the communication between a user device and a customs declaration system through the Internet.

The logistics pre-arrival declaration system comprises a declaration form generating interface module, a form-checking and comparing unit, and a database group, wherein the database group includes a marine shipping database, a product database, an exporter database, an importer database, a marine shipping company database, and a freight forwarding agency database.

Through the above system framework, the system of the present disclosure is connected to the customs declaration system, and the system saves the marine shipment information in the database group when users such as marine shipping companies and freight forwarding agencies upload the marine shipment information. After the user executes the declaration form generating interface module, the system fills the data of the database group into the field of the generated form in the declaration form generating interface module. The users would only require confirming that the content of the generated form is correct, and the declaration form can be uploaded to the customs declaration system.

### BRIEF DESCRIPTION OF THE DRAWINGS

The described embodiments may be better understood by reference to the following description and the accompanying drawings in which:

FIG. 1 is a block schematic diagram of the logistics pre-arrival declaration system of the present disclosure;

FIG. 2 is another block schematic diagram of the logistics pre-arrival declaration system of the present disclosure;

FIG. 3 is a schematic diagram of the communication between the user device and the customs declaration system through the logistics pre-arrival declaration system of the present disclosure; and

FIG. 4 is a flowchart of the operating method of the logistics pre-arrival declaration system of the present disclosure.

### DETAILED DESCRIPTION OF THE PREFERRED EMBODIMENTS

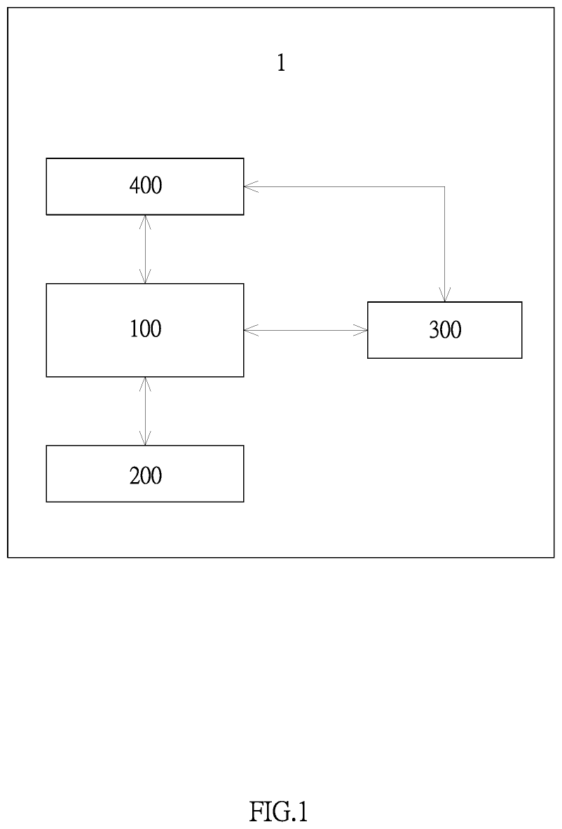

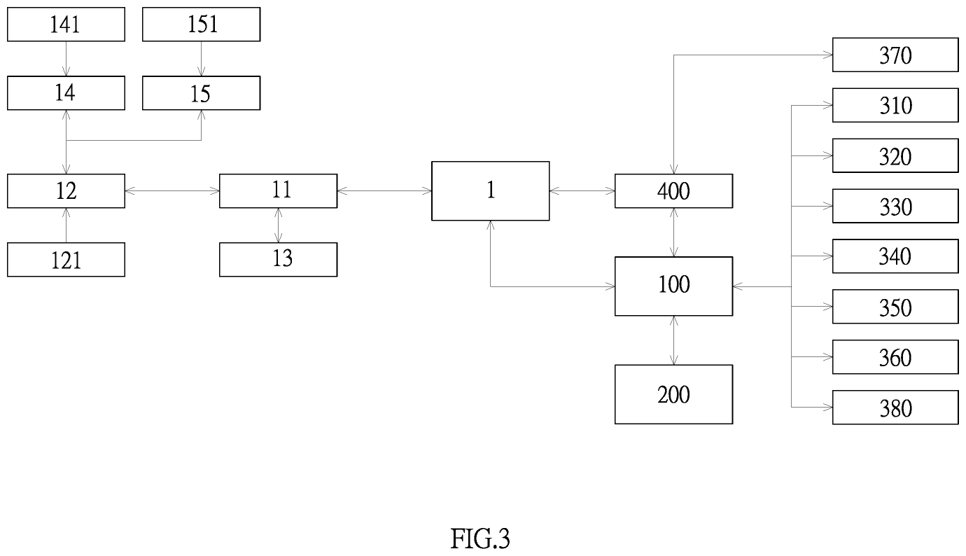

Referring to FIGS. 1-3, The present disclosure provides a logistics pre-arrival declaration system 1, which is connected with the communication between a user device 12 and a customs declaration system 13 through the Internet 11.

In detail, the logistics pre-arrival declaration system 1 includes a declaration form generating interface module 100, a form-checking and comparing unit 200, and a database group 300.

The database group 300 includes a marine shipping database 310, a product database 320, an exporter database 330, an importer database 340, a marine shipping company database 350, and a freight forwarding agency database 360.

Through the above system framework, the system connects to the customs declaration system 13. It provides the user device 12 (such as the importer or the marine shipping company organization 14 or the freight forwarding agency 15) and other users to upload the marine shipment information 121, 141, 151. The system will save the marine shipment information in the database group 300. After the user executes the declaration form generating interface module 100, the system fills the data of the database group 300 into the field of the generated form in the declaration form generating interface module 100. The users would only require confirming that the content of the generated form is correct, and the declaration form can be uploaded to the customs declaration system 13.

The form-checking and comparing unit 200 is used to check the format and type of the data filled into columns of the generated form, and whether it meets the requirements of each column, so as to avoid errors in uploading the wrong format of the declaration form to the customs declaration system 13 without being aware of it.

The marine shipment information includes the American manifest system (AMS): House BL Number, Carrier Master BL No, Carrier Name, Shipper, Consignee, Notify Party, Place of Receipt, Vessel/Voyage, Port of Loading, Port of Discharge, Destination, Container Number, Seal Number, Size/Type, No. & PKG Type, Weight, CBM, Description of Goods, Marks & Numbers; and Importer Security Filing (ISF): Manufacturer name and address, Seller name and address, Buyer name and address, Ship to name and address, Importer of record number, Consignee number, Country of origin of the goods, Harmonized Tariff Schedule Number (6 digits), Container stuffing location, Consolidator name, and address.

For example, after the goods are packed in containers, they are transported to the United States by marine, and the American manifest system (AMS), and Importer Security Filing (ISF) are required to report to U.S. Customs and Border Protection (CBP).

The information of AMS includes House BL Number, Carrier Master BL No, Carrier Name, Shipper, Consignee, Notify Party, Place of Receipt, Vessel/Voyage, Port of Loading, Port of Discharge, Destination, Container Number, Seal Number, Size/Type, No. & PKG Type, Weight, CBM, Description of Goods, Marks & Numbers.

Further, ISF declares cargo information to the US Customs 24 hours before arrival at the port (shipment). The importer provides 10 declaration contents, and the marine shipping company provides 2 declaration contents.

The 10 declaration contents of ISF that provides by the importer are Manufacturer name and address, Seller name and address, Buyer name and address, Ship to name and address, Importer of record number, Consignee number, Country of origin of the goods, Harmonized Tariff Schedule Number (6 digits), Container stuffing location, and Consolidator name and address.

The 2 declaration contents of ISF provided by the marine shipping company are Vessel stow plan and Container status message.

Since the importer is unfamiliar with the part mentioned above of the ISF and timeliness regulations, usually the freight forwarding agency 15 or the shipping agency will assist with this part to ensure it meets the due time. Therefore, by this system, the user can upload the marine shipment information and conveniently and easily report the declaration documents to the customs declaration system 13. The marine shipping company organization 14/freight forwarding agency 15 has a heavy volume of work. Through the system of the present disclosure, it is not necessary to manually input various data as in the past. It can effectively simplify work and improve the work efficiency of related industries.

The user device 12 can be a desktop PC, notebook computer, or wireless communication smartphone. The Internet 11 that communicates between the logistics pre-arrival declaration system 1 and the user device 12 can be a communication protocol of optical fiber, wired, or wireless network.

In certain embodiments, the system further includes a login module 400, and the database group 300 includes a user database 370. Through the login module 400, the system allows the user to create an exclusive account and password and save the aforementioned exclusive account and password in the user database 370. The user will be allowed for further operations, access, and upload operations of the system under the condition of a valid account number and password.

In certain embodiments, the database group 300 includes a form-generating database 380. After the declaration form is uploaded to the customs declaration system 13, the declaration form is backed up and saved in the form-generating database 380 for future reference by users or related personnel.

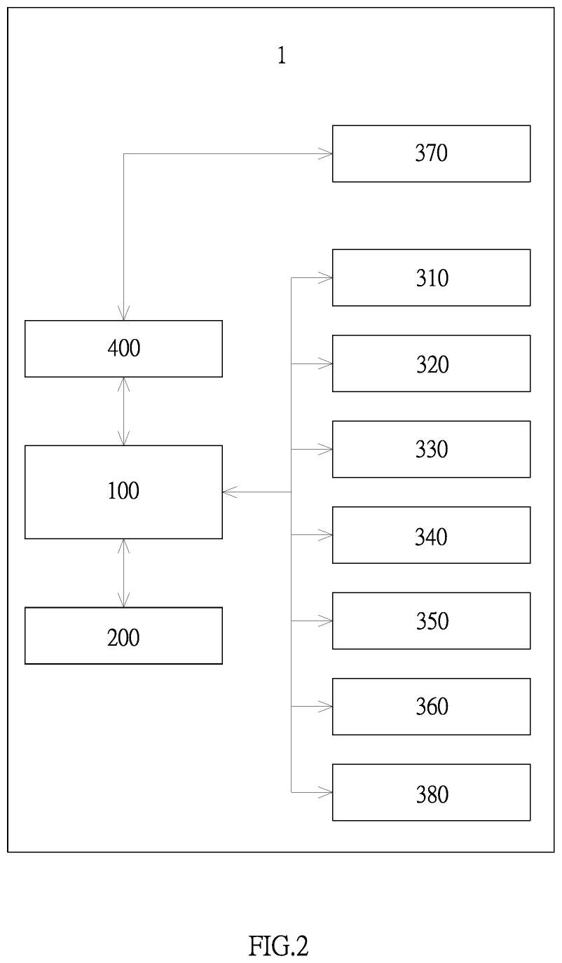

Regarding the operating method of the logistics pre-arrival declaration system of the present disclosure, which can be read in conjunction with FIGS. 2-4. The operating method includes the following steps:
S01 user login step. The user connects to the logistics pre-arrival declaration system 1 via the Internet through the client terminal 12 and enters a valid account number and password to operate the system after obtaining qualified certification;
S02 marine shipment information upload step; The user uploads the marine shipment information to the logistics pre-arrival declaration system 1 in the form of an electronic file via the user device 12;
S03 saving the marine shipment information in a database group step; Save the text and values of the electronic file of the marine shipment information in the database group 300, and further classify and access it in each database;
S04 executing a declaration form generating interface module step; The user executes the declaration form generating interface module 100, for example, choosing the arrival country to display the declaration form required by the arrival country;
S05 inputting the information of the database group in the generated form step; After the above steps are completed, the system substitutes the data of the database group 300 into the declaration form generating interface module 100, so that text or numerical data can be filled in each column of the generated form;
S06 checking generated form step; and after completing filling in the information in each field of the system, the user only needs to check whether the information in the generated form is correct; and
S07 uploading the declaration form to the customs declaration system step; After confirming the content of the generated form is correct, the declaration form can be uploaded to the customs declaration system 13.

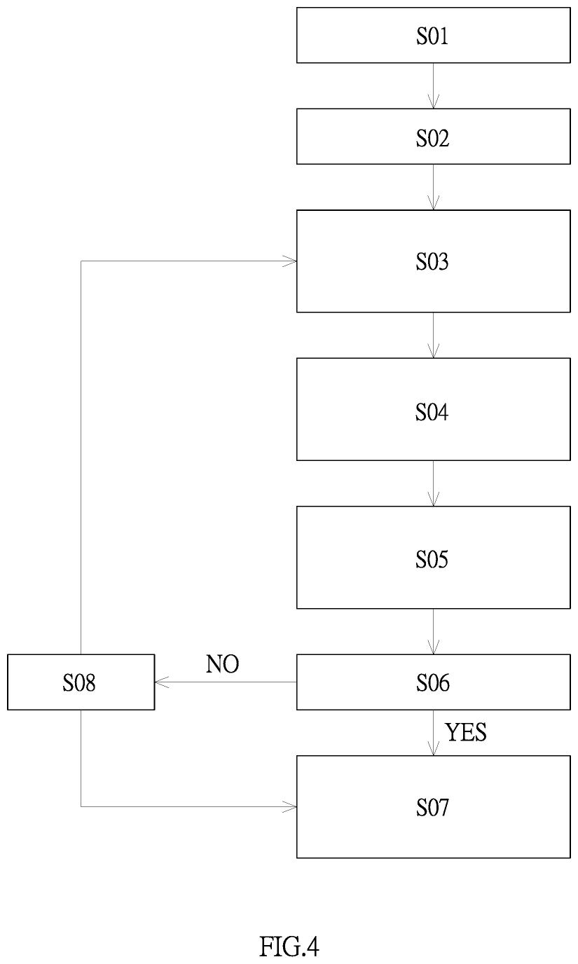

Further, the method includes an editing step S08. When an error in the generated form of the S06 checking generated form step, the editing step S08 can be executed online, and then the edited generated form is uploaded to the customs declaration system 13. As shown in FIG. 4, when there is no error in S06 checking generated form step (YES), the system enters the next step, that is, S07 uploading the declaration form to the customs declaration system step. On the other hand, when there is an error in S06 checking generated form step (NO), such as an obvious error in the field data that does not match, the editing step S08 can be processed for immediate correction. After the editing step S08 is completed, the declaration form can be uploaded to the customs declaration system in step S07.

After executing the editing step S08, correcting the edited data to the marine shipment information of the database group 300. Then the step returns to marine shipment information saving in a database group step S03. The edited and corrected form is saved in the form-generating database 380 with records such as the editing time and the correction content. The records as mentioned above are not editable and only provided for reference, so that users\customs or relevant personnel can check them in the future.

What is claimed is:

1. A logistics pre-arrival declaration system, which is connected with the communication between an user device and a customs declaration system through the Internet, wherein:
the logistics pre-arrival declaration system comprising a declaration form generating interface module, a form-checking and comparing unit and a database group;
wherein the database group includes a marine shipping database, a product database, an exporter database, an importer database, a marine shipping company database and a freight forwarding agency database.

2. The logistics pre-arrival declaration system according to claim 1, wherein the logistics pre-arrival declaration system includes a login module, and the database group includes a user database.

3. The logistics pre-arrival declaration system according to claim 1, wherein the database group includes a form-generating database.

4. An operating method of the logistics pre-arrival declaration system according to claim 1, further including:
user login step;
marine shipment information upload step;
marine shipment information saving in a database group step;
executing a declaration form generating interface module step;
inputting the information of the database group in the generated form step;
checking generated form step; and
uploading a declaration form to the customs declaration system step.

5. The operating method of the logistics pre-arrival declaration system according to claim 4, further including: editing step; wherein when an error in the generated form of the checking generated form step, the editing step can be executed online, and then the edited generated form is uploaded to the customs declaration system.

6. The operating method of the logistics pre-arrival declaration system according to claim 5, further including: correcting the edited data to the marine shipment information of the database group after executing the editing step.
